(19) United States
(12) Patent Application Publication
(10) Pub. No.: US 2002/0185210 A1
(43) Pub. Date: Dec. 12, 2002

(54) Process for improving the adhesion of a tire to dry ground

(75) Inventor: Valery Poulbot, Les Martres-D'Artiere (FR)

Correspondence Address: BAKER & BOTTS, 30 ROCKEFELLER PLAZA, NEW YORK, NY, 10112

(73) Assignee: Michelin Recherche et Technique S.A.

(21) Appl. No.: 10/135,692

(22) Filed: Apr. 30, 2002

Related U.S. Application Data
(63) Continuation of application No. PCT/EP01/09857, filed on Aug. 27, 2001.

(30) Foreign Application Priority Data
Sep. 1, 2000 (FR) 00/11255

(51) Int. Cl. B29D 30/00

(52) U.S. Cl. 156/126; 156/123

(57) ABSTRACT

A process for improving the adhesion of a tire cover to dry ground includes providing a tire cover having a tread comprised of an electrically insulating material which is delimited radially by inner and outer faces and laterally by two lateral faces connecting between them the radially inner and outer faces of the tread, and further providing at least one circumferentially extending conductive layer which substantially connects the lateral faces to one another, the conductive layer having a resistivity less than that of the insulating material, which insulating material is provided radially on either side of the conductive layer in the tread.

### CROSS REFERENCE TO RELATED APPLICATIONS

This present application is a continuation of international application PCT/EP 01/09857, filed Aug. 27, 2001 and first published in French on Mar. 7, 2002 as international publication WO 02/18159, which claims priority to French application No. 00/11255, filed Sep. 1, 2000.

### BACKGROUND OF THE INVENTION

1. Technical Field of the Invention

The present invention relates to a process for improving the adhesion of a tire cover to dry ground, and, more particularly, to the use of a particular tread structure which allows such adhesion to be improved.

2. The Related Art

An attempt has been made in the past to improve the adhesion of tire covers by using treads which have relief elements on their respective outer faces (ribs, blocks). These relief elements are separated from one another in the circumferential direction and/or in the transverse direction by circumferential and/or transverse grooves. They also have numerous incisions or slots whose width is much smaller than that of the grooves.

These incisions or slots may be normal with respect to the outer surface of the corresponding tread or inclined with respect to the direction perpendicular to the outer surface. Two adjacent incisions delimit between them mobile sipes that deform during travel, which tends to improve adhesion.

There have also been attempts to improve the adhesion of tire covers, for example on dry ground, by incorporating into the elastomer matrix of a given composition of tread a bituminous resin having a relatively high glass transition temperature (Tg), which may in particular be between 40° C. and 120° C.

It is an object of the present invention to provide a tread having a novel structure which allows the adhesion on dry ground of the corresponding cover to be further improved.

### SUMMARY OF THE INVENTION

The Applicant has discovered that, surprisingly, the foregoing object is attained by providing in a tire cover a tread comprised of electrically insulating material, at least one circumferentially extending conductive layer which substantially connects the lateral faces of the tread to one another and which has a resistivity less than that of the insulating material, which insulating material is provided on either radial side of the at least one conductive layer in the tread.

According to a variant embodiment of the invention, the at least one conductive layer substantially connects the lateral faces to one another such that it is interrupted at a location opposite at least one of the lateral faces.

According to another variant embodiment in accordance with the invention, the at least one conductive layer substantially connects the lateral faces to one another such that it is interrupted at least at one location opposite the radially inner and outer faces.

According to another feature of the invention, the at least one conductive layer is substantially parallel to the outer face.

According to another feature of the invention, the tread has a single conductive layer provided at a spacing from one or the other of the inner and outer faces that is greater than or equal to a quarter of the thickness of the tread. Preferably, the spacing is equal to half the thickness of the tread.

Preferably, the resistivity of the at least one conductive layer is provided to be less than or equal to 10⁸ Ω.cm, and the resistivity of the insulating material is provided to be greater than or equal to 10⁸ Ω.cm.

According to a particular embodiment of the invention, the tread further has at least one conductive film which is provided in order to electrically connect the inner and outer faces to one another. Preferably, the tread in such case has two conductive films which are respectively provided at the locations of the lateral faces. Even more preferably for this embodiment, the films are extended respectively over the outer face by two electrically conductive, circumferential and peripheral bands.

According to a variant of this particular embodiment of the invention, the tread has between the lateral faces at least one electrically conductive film which connects the inner and outer faces to one another.

According to another variant of this particular embodiment of the invention, the tread has, on the one hand, at least one inner conductive strip connecting the at least one conductive layer to the radially inner face and, on the other hand, at least one outer conductive strip connecting the at least one conductive layer to the radially outer face.

### BRIEF DESCRIPTION OF THE DRAWINGS

The above-mentioned features of the present invention and others will be better understood from the following description of an exemplary embodiment of the invention which is given by way of non-restrictive illustration, the description being given in relation to the attached drawings, in which:

FIG. 1 is a diagrammatic view in radial section of a tread according to a first embodiment of the invention;

FIG. 2 is a diagrammatic view in radial section of a tread according to a second embodiment of the invention;

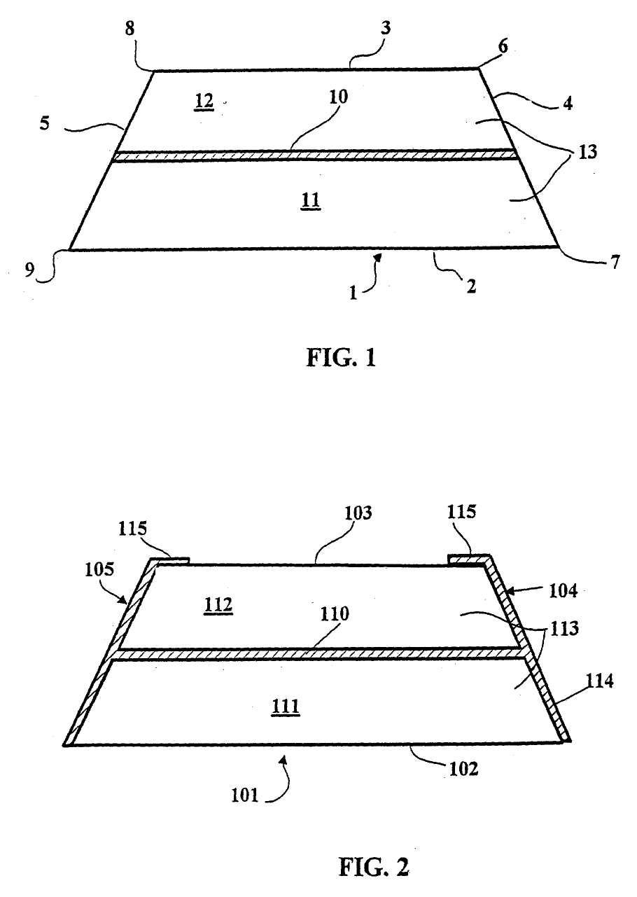

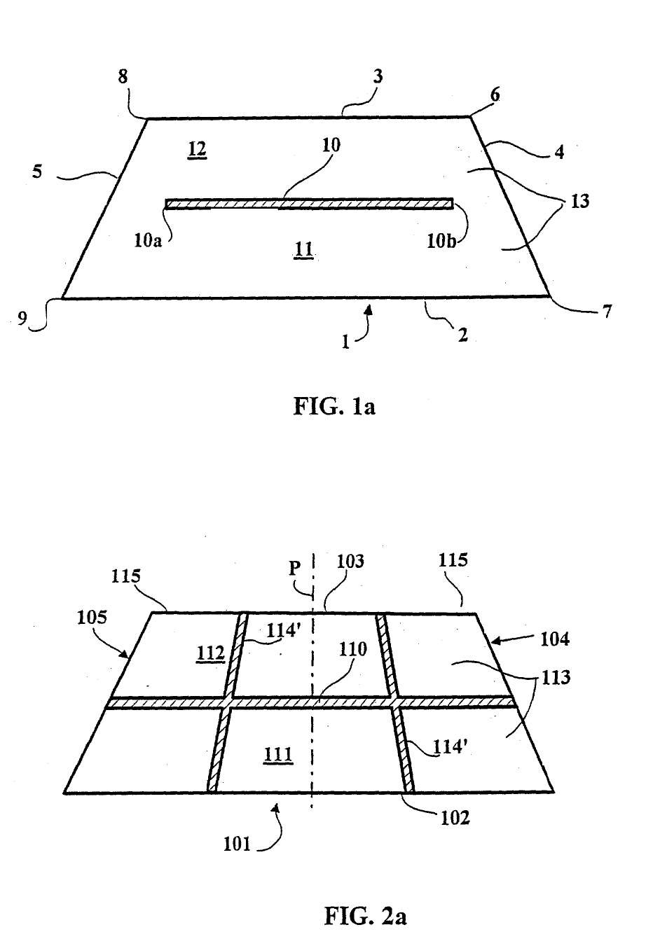

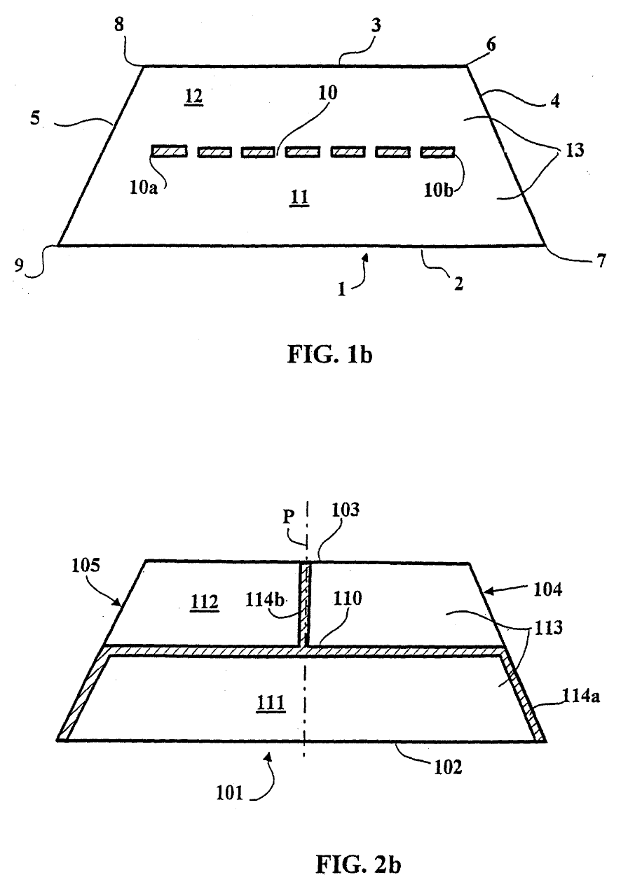

FIG. 1a is a diagrammatic view in radial section of a tread according to a first variant of the first embodiment of the invention;

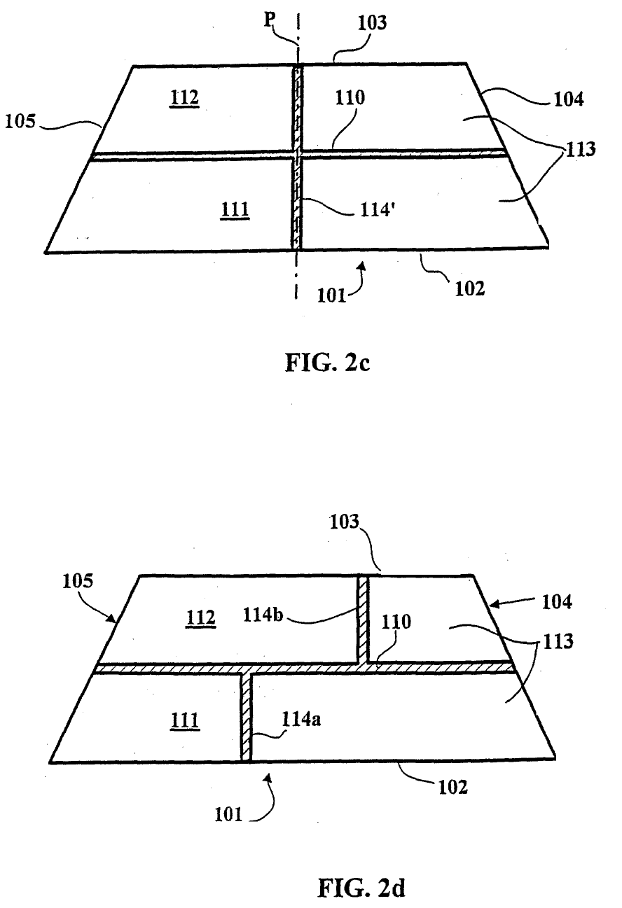

FIG. 2a is a diagrammatic view in radial section of a tread according to a first variant of the second embodiment of the invention;

FIG. 1b is a diagrammatic view in radial section of a tread according to a second variant of the first embodiment of the invention;

FIG. 2b is a diagrammatic view in radial section of a tread according to a second variant of the second embodiment of the invention;

FIG. 2c is a diagrammatic view in radial section of a tread according to a third variant of the second embodiment of the invention; and

FIG. 2d is a diagrammatic view in radial section of a tread according to a fourth variant of the second embodiment of the invention.

### DETAILED DESCRIPTION OF EXEMPLARY EMBODIMENTS

(a) Treads which may be Used in the Process According to the Invention

The tread 1 shown in FIG. 1 has a substantially trapezoidal radial section purely for reasons of simplification. It will be understood that it could have any shape considered appropriate, including tread patterns, for the type of tire selected.

The tread 1 is delimited by a radially inner face 2 intended to be opposite different reinforcements of a tire (not shown), a radially outer face 3 intended to deform in contact with the ground during travel, and two lateral faces 4 and 5 connecting the two pairs of opposing lateral edges 6, 7 and 8, 9 of the faces 2 and 3 to one another.

The tread 1 is based on an electrically insulating material comprising, for example, a non-conductive reinforcing filler such as silica.

As can be seen in the example of FIG. 1, the tread 1 includes a circumferential conductive layer 10 which substantially connects the lateral faces 4 and 5 to one another, such that the aforementioned insulating material is provided on either radial side 11 and 12 of the layer 10.

In the example of FIG. 1, the tread 1 has a single conductive layer 10 which is provided substantially parallel to the outer face 3.

However, a tread 1 according to the invention could have a plurality of such conductive layers 10, provided that the insulating material is provided on either side of each layer 10.

Preferably, the conductive layer 10 shown in the example of FIG. 1 is located at a spacing from one or the other of the inner and outer faces 2, 3 which is preferably greater than or equal to a quarter of the thickness of the tread 1. Even more preferably, the conductive layer 10 is provided at the same spacing from the inner and outer faces 2 and 3, i.e., at the radial midpoint of the tread 1.

It will be noted that a conductive layer 10 according to the invention is characterized by a resistivity less than that of the zone 13 occupied by the insulating material in the tread 1. By way of example, the resistivity of the conductive layer 10 is less than or equal to 10⁸ Ω.cm, while the resistivity of the insulating material is greater than or equal to 10⁸ Ω.cm.

The conductive layer 10 is, for example, formed by a mixture of elastomers with carbon black filler, the content of carbon black being determined as a function of the resistivity sought.

According to a variant embodiment, the conductive layer 10 can be obtained from a liquid solution applied to one of the parts 11, 12 of the tread 1, the solution comprising an electrically conductive mixture and an extending solvent.

Moreover, the conductive layer 10 may have a variable thickness by comparison with that of the tread, for example, advantageously between 0.5 mm and 2.5 mm, to give a total thickness of tread 1 of approximately 1.2 cm on average.

FIG. 2 shows a second embodiment of the tread 1 of FIG. 1, the elements thereof which are identical here being respectively identified by reference numerals incremented by 100.

A tread 101 according to FIG. 2 is distinguished from the tread 1 by having at least one radial conductive film 114 which is provided to electrically connect the outer face 103 to the inner face 102 of the tread 101.

In the example embodiment of FIG. 2, it can be seen that the tread 101 has two conductive films 114 which are respectively provided at the locations of the lateral faces 104 and 105 of the tread 101 and which are preferably respectively extended on the outer face 103 by two circumferential peripheral bands 115, which are also conductive and of variable width. It will be noted that the conductive films 114 may have a different thickness from that of the conductive layer 110.

As regards the resistivity of the films 114, in this example embodiment it is preferably substantially equal to that of the layer 110.

It will also be noted that the axial conductive layers 10, 110 according to FIGS. 1 and 2 do not each have a rigorously linear radial section in practice, as is illustrated diagrammatically, but a more or less irregular section which is the result of pressure constraints inherent in the molding of the tire. Each conductive layer 10, 110 could, for example, have a substantially wavy radial section, or one in the form of broken lines, provided it extends between the lateral faces 4, 104 and 5, 105 and over the entire circumference of the tire incorporating it.

FIGS. 1a and 1b, on the one hand, and FIGS. 2b, 2c and 2d, on the other hand, illustrate variant embodiments of the treads shown in FIGS. 1 and 2, respectively. The elements of the FIGS. 1a, 1b, 2b, 2c and 2d which fulfill functions similar to those of the elements in FIGS. 1 and 2 are identified by the same reference numerals.

The treads 1 of FIGS. 1a and 1b, like that of FIG. 1, are also such that the conductive layer 10 that each of them has substantially connects the said lateral faces 4 and 5 to one another.

More particularly, the layer 10 of FIG. 1a is interrupted opposite each of the lateral faces 4 and 5 of the tread 1, that is to say each of the lateral edges 10a, 10b of the layer 10 is spaced from the lateral face opposite 4 or 5. By way of non-restrictive explanation, each edge 10a, 10b may be spaced from the opposite lateral face 4 or 5 by a spacing equal for example to 5% of the width of the tread 1 at the location of the layer 10.

It will be noted that a layer 10 according to this variant embodiment could be such that only one of its lateral edges 10a or 10b is spaced from the opposite lateral face 4 or 5.

As regards the layer 10 in FIG. 1b, it differs from that in FIG. 1a in that it is furthermore interrupted between the inner and outer faces 2 and 3 of the tread 1, that is to say, it has between its edges 10a and 10b a plurality of interruptions 10c in the form of circumferential channels.

The treads 101 of FIGS. 2a to 2d, like that of FIG. 2, are also such that the conductive layer 110 that each of them has substantially connects the lateral faces 104 and 105 to one another. It will be understood that a tread 101 according to one of FIGS. 2a to 2d could, for example, be such that the conductive layer 110 it has fulfills the description given above with reference to FIGS. 1a and 1b.

More particularly, the tread 101 of FIG. 2a differs from that of FIG. 2 in that it has, instead of the films 114, two conductive films 114′ located between the lateral faces 104, 104 and which electrically connect the inner and outer faces 102 and 103 of the tread 101 to one another. The two films 114′ are, in this example, symmetrical to one another with respect to the circumferential median plane P of the tread 101.

It will be noted that a tread 101 according to the variant embodiment of FIG. 2a could have more than two conductive films 114′, and that each film 114′ could have a predetermined incline, different from that shown in FIG. 2a, with respect to the circumferential median plane P.

As regards the tread 101 of FIG. 2c, it differs from that of FIG. 2a in that it has between its lateral faces 104 and 105 a single conductive film 114′ connecting the faces 102 and 103 to one another, in this example the film being provided at the location of the median plane P.

The tread 101 of FIG. 2b differs from that of FIG. 2 in that it has, on the one hand, two inner conductive strips 114a which are respectively provided at the locations of the lateral faces 104 and 105 and which connect the conductive layer 110 to the inner face 102 and, on the other hand, an outer conductive strip 114b which is provided between the lateral faces 104 and 105 and which connects the layer 110 to the outer face 105. In the example of FIG. 2b, the external strip 114b is provided at the location of the circumferential median plane P.

It will be noted, however, that a tread 101 according to the variant embodiment of FIG. 2b could have one or more outer strips 114b, each possibly having a different geometry and a different incline with respect to the plane P, provided that it connects the layer 110 to the outer face 105.

As regards the tread 101 of FIG. 2d, it also has an outer strip 114b like that in FIG. 2b, but it differs from that of FIG. 2b in that it has a single inner strip 114a which connects the inner face 102 to the conductive layer 110, the internal strip 114a being located between the lateral faces 104 and 105.

It will be noted that the films 114′ and the conductive strips 114a and 114b may have a different thickness from that of the said or of each conductive layer 110.

As regards the resistivity of the films 114′ and the strips 114a and 114b, it is preferably substantially equal to that of the layer 110 in these variant embodiments.

(b) Adhesion to Dry Ground of the Covers According to the Invention

The longitudinal adhesion on dry ground of tire covers according to the invention, of which the respective treads 1, 101 are shown in FIGS. 1, 2, 1a, 2a, 1b, 2b, 2c and 2d, has been evaluated as described below.

Two series of tests according to the invention were respectively carried out with two sets of covers according to the invention, the covers of each of these two sets having a tread 101 according to FIG. 2, by comparison with two series of control tests which were carried out with two sets of control covers, the covers of each of these last two sets having a tread with no conductive layer.

In the first set of covers according to FIG. 2, which was tested for a first series of tests according to the invention, the tread of each cover had a thickness of approximately 1.2 cm of a composition of insulating rubber (of resistivity greater than or equal to 10¹³ Ω.cm and, by way of a conductive layer 110, a layer whose the thickness was approximately 0.5 mm and whose resistivity was substantially equal to 10³ Ω.cm.

More particularly, the composition of insulating rubber was of the type sold by Michelin under the trade name MXT ENERGY. This insulating composition essentially comprises an elastomer matrix based on a blend of a styrene/butadiene copolymer prepared in solution (also called S-SBR) and a polybutadiene (BR) with a high number of cis-1,4 chains, and silica by way of reinforcing filler in a quantity of approximately 80 ppc (parts by weight per hundred parts of elastomer).

In the second set of covers according to FIG. 2, which was tested in a second series of tests according to the invention, the tread of each cover had all of the features mentioned above in relation to the first set, except that the composition of insulating tread rubber was of the type sold by Michelin under the trade name MXGS GREEN. This insulating composition is substantially the name as that of the MXT ENERGY composition, except that the MXGS GREEN composition includes, as a reinforcing filler, a mixture of carbon black of ≈33% by weight and silica of ≈67% by weight.

The tread of each cover for the first set of control covers, which was tested for a first series of control tests, was made up only of the insulating composition MXT ENERGY mentioned in relation to the first set according to FIG. 2.

The tread of each cover for the second set of control covers, which was tested for a second series of control tests, was made up only of the insulating composition MXGS GREEN mentioned in relation to the second set according to FIG. 2.

A longitudinal adhesion test was used, consisting of measuring the braking distance on dry ground from 100 km/h to 0 km/h, with a private motor vehicle equipped with an ABS system on all four wheels.

This test was carried out in a straight line of a motor-way type circuit, this straight line being uniformly dry and clean (leaves, grass, birds or any objects borne on the wind having been removed).

More particularly, the test method consisted in measuring the distance covered by the vehicle between 100 km/h and 0 km/h, the vehicle previously travelling at a speed of 105 km/h and being subjected to automatic braking by on-board equipment.

The on-board measuring equipment essentially comprised:

a measurement panel for programming the test speeds (100 km/h and 0 km/h), management of enabling braking, triggering and automatically stopping braking in the four braked wheel mode, and displaying the speed and measured distance;

an ABS measuring wheel indicating the current speed and transmitting a number of “pips” to the measurement panel;

a galvanometer with zero in the center, for indicating the initial speed (105 km/h) on the circuit and the reproducibility from one pass to the next; and

a magnetic sensor intended to co-operate with a magnetic strip positioned on the motor-way circuit in order to trigger the braking procedure.

A vehicle of the Renault make, model Laguna 2.0I, was used, characterized by a load on the front axle of 788 kg and a load on the rear axle of 596 kg.

For the first series of tests (including the control tests using covers of the MXT ENERGY type), wheels having rim dimensions of 5.5J14 and covers having the dimension 175/70 R14 inflated to a pressure of 2.1 bar were used.

For the second series of tests (including the control tests using covers of the MXGS GREEN type), wheels having rim dimensions of 6J15 and covers having the dimension 195/65 R15, also inflated to a pressure of 2.1 bar, were used.

Ten braking measurements were carried out for each series of control tests, for each first series of tests according to the invention and, similarly, for the second series of tests, alternating within a single series the direction of travel in the straight line.

For each series according to the invention, the average of the braking distances measured was determined (as a relative value, that is to say with respect to the average of the braking distances for the corresponding control series), as was the efficiency (out of 100) with respect to the control series. This efficiency (in %) is defined by the following equation:

efficiency=100×(2.dT−d)/dT,

where dT is the average value of the braking distances for the control value and d is the average value of the braking distances for the series according to the invention.

The table below sets out the results obtained, on the one hand, for the first two series of tests, and, on the other hand, for the second two series of tests.

| | First series of tests | | Second series of tests (MXGS | |
|---|---|---|---|---|
| | (MXT ENERGY type covers) | | GREEN type covers | |
| | First control | First series of the | Second control | Second series of |
| | series | invention | series | the invention |
| Air T (° C.) | 21 | 20 | 14 | 14 |
| Ground T (° C.) | | | 27 | 28 |
| Wind speed (m/s) | 0 | 1 | 0 | 1 |
| Average of | dT | d = 98.1% dT | dT | d = 96.3% dT |
| braking distances | | | | |
| Efficiency (%) | 100.0 | 101.9 | 100.0 | 103.7 |

In conclusion, it is clear that a tread having a conductive layer according to the invention allows the braking distance on dry ground to be significantly reduced as compared to the braking distance obtained with conventional treads without such a conductive layer.

What is claimed is:

1. A process for improving the adhesion of a tire cover to dry ground, comprising the steps of:
(a) providing a tread cover having a tread comprised of an electrically insulating material having radially inner and outer faces interconnected by two lateral faces; and
(b) providing in said tread at least one circumferentially extending conductive layer which substantially connects the lateral faces to one another, the conductive layer having a resistivity less than that of said insulating material and having said insulating material provided on either radial side thereof.

2. A process for improving the adhesion on dry ground according to claim 1, wherein said at least one conductive layer substantially connects the lateral faces to one another such that it is interrupted at a location opposite at least one of the lateral faces.

3. A process for improving the adhesion on dry ground according to claim 1, wherein said at least one conductive layer substantially connects the lateral faces to one another such that it is interrupted at least at one location opposite the radially inner and outer faces.

4. A process for improving the adhesion on dry ground according to claim 1, wherein said at least one conductive layer is substantially parallel to the outer face.

5. A process for improving the adhesion on dry ground according to claim 1, wherein step (b) comprises providing a single conductive layer at a spacing from one of the inner and outer faces which is greater than or equal to a quarter of the thickness of the tread.

6. A process for improving the adhesion on dry ground according to claim 5, wherein said spacing is equal to half the thickness of the tread.

7. A process for improving the adhesion on dry ground according to claim 1, wherein the resistivity of said at least one conductive layer is provided to be less than or equal to 10⁸ Ω.cm, and the resistivity of said insulating material is provided to be greater than or equal to 10⁸ Ω.cm.

8. A process for improving the adhesion on dry ground according to claim 1, further comprising the step of providing at least one conductive film on the tread so as to electrically connect the inner and outer faces to one another.

9. A process for improving the adhesion on dry ground according to claim 8, wherein two conductive films are respectively provided at the locations of the lateral faces.

10. A process for improving the adhesion on dry ground according to claim 9, wherein said two films are extended respectively over the outer face by two electrically conductive, circumferential and peripheral bands.

11. A process for improving the adhesion on dry ground according to claim 8, wherein said at least one electrically conductive film which connects the inner and outer faces to one another is located between the lateral faces.

12. A process for improving the adhesion on dry ground according to claim 1, further comprising the steps of providing at least one inner conductive strip connecting said at least one outer conductive layer to the radially inner face and at least one outer conductive strip connecting said at least one conductive layer to the radially outer face.
